(19) United States
(12) Patent Application Publication
(10) Pub. No.: US 2008/0035567 A1
(43) Pub. Date: Feb. 14, 2008

(54) Enhanced membrane separation system

(76) Inventor: Craig Y. Sabottke, Annandale, NJ (US)

Correspondence Address: ExxonMobil Research and Engineering Company, P.O. Box 900, Annandale, NJ, 08801-0900, US

(21) Appl. No.: 11/890,229

(22) Filed: Aug. 3, 2007

Related U.S. Application Data
(60) Provisional application No. 60/836,425, filed on Aug. 8, 2006.

(51) Int. Cl. B01D 71/60; B01D 61/36; B01D 71/68; B01D 71/06

(52) U.S. Cl. 210/640; 210/500.27; 210/500.28; 210/500.35; 210/500.36; 210/500.37; 210/650; 210/651

(57) ABSTRACT

The present invention includes a polymeric membrane assembly and method for selective separation of components of a feedstream utilizing the polymeric membrane assembly. The present invention is a novel concept for the manufacture and use of a polymeric membrane assemblies which require the use of fibrous backing materials for fabrication processes utilizing commercial membrane casting equipment. This invention involves as improved membrane assembly configuration and membrane separation process configuration resulting in improved flux and selectivity properties for a given polymeric membrane composition.

### CROSS-REFERENCE TO RELATED APPLICATIONS

This application is a U.S. utility application which claims priority to U.S. Provisional Patent Application Ser. No. 60/836,425, filed Aug. 8, 2006.

### FIELD OF THE INVENTION

This invention relates to a polymeric membrane assembly and a process for separating components of a feedstream utilizing the polymeric membrane assembly. More particularly, but not by way of limitation, this invention relates to an improved process for the separation of aromatics from a hydrocarbon feedstream via a polymeric membrane assembly.

### BACKGROUND OF THE INVENTION

Polymeric membrane based separation processes such as reverse osmosis, pervaporation and perstraction are conventional. In the pervaporation process, a desired feed component, e.g., an aromatic component, of a mixed feedstream is preferentially absorbed by the membrane. The membrane is exposed at one side to a stream comprised of a mixture of liquid feeds and a vacuum is applied to the membrane at the opposite side so that the adsorbed component migrates through the membrane and is removed as a vapor from the opposite side of the membrane via a solution-diffusion mechanism. A concentration gradient driving force is therefore established to selectively diffuse the desired components through the membrane from the retentate (feedstream) side to the permeate side of the membrane.

The perstraction process is utilized to separate a feedstream into separate products. In this process, the driving mechanism for the separation of the stream into separate products is provided by a pressure/concentration gradient exerted across the membrane. Certain components of the fluid will preferentially migrate across the membrane because of the physical and compositional properties of both the membrane and the process fluid, and will be collected on the other side of the membrane as a permeate. Other components of the process fluid will not preferentially migrate across the membrane and will be swept away from the feed side membrane area as a retentate stream. Due to the pressure mechanism of the perstraction separation, it is not necessary that the permeate be extracted in the vapor phase. Therefore, no vacuum is required on the permeate side of the membrane and the permeate emerges from the permeate side of the membrane in the liquid phase.

The economic basis for performing such separations is that the two products achieved through this separation process (i.e., retentate and permeate) have a refined value greater than the value of the unseparated the feedstream. Membrane technology based separations can provide a cost effective processing alternative for performing the product separation of such feedstreams. Conventional separation processes such as distillation and solvent extraction can be costly to install and operate in comparison with membrane process alternatives. These conventional based processes can require significant amounts of engineering, hardware and construction costs to install and then may require considerable levels of operational and maintenance personnel and costs to maintain the facility in an operating status. Additionally, most of these processes require the heating of the process streams to relatively high temperatures in order to separate different components resulting in higher energy costs than are generally required by comparable membrane separation processes.

Theoretically, membrane separations technologies can benefit from lower per unit energy costs per volume of separation than many of the conventional separations technologies in present art. However, a major obstacle in perfecting the commercial operation of membrane separation technologies is to improve the flux and selectivity of the current membrane systems in order to make the construction costs and capacity of membrane technologies economical viable in large scale manufacturing and installations.

A myriad of polymeric membrane compositions have been developed over the years. Such compositions include polyurea/urethane membranes (U.S Pat. No. 4,914,064); polyurethane imide membranes (U.S. Pat. No. 4,929,358); polyester imide copolymer membranes (U.S. Pat. No. 4,946,594); and diepoxyoctane crosslinked/esterfied polyimide/polyadipate copolymer (diepoxyoctane PEI) membranes (U.S. Pat. No. 5,550,199).

These copolymeric membranes are generally comprised of “soft segments” and “hard segments” which form polymer chains in the membrane solution. The soft segments of the polymer provide the active area for the selective diffusion of the permeate through the membrane. However, these soft segments of the membrane have limited structural and thermal strength characteristics. Therefore, in order to provide structural strength to the membrane, polymers are combined to form a hard and soft polymer segments in long copolymer chains in the final membrane. Preferably, these copolymer chains are comprised of alternating soft and hard polymer segments. The hard segments provide most of the mechanical and thermal stability of the membrane, but are essentially non-permeable to the process stream components.

Generally, for a given polymeric membrane composition, the flux across the membrane is approximately inversely proportional to the thickness of the membrane. Therefore, the thickness of a constructed membrane can be very thin (on the order of about 0.1 to about 50 microns in cross-section) in order derive the selectivity benefit of the membrane while maximizing the flux characteristics of the membrane. However, problems associated with the fabrication and operation of thin membranes include voids and inconsistencies in the membrane structure as well as a lack of mechanical strength in the fabricated membranes.

Most commercial equipment membrane casting equipment and techniques require that the polymer membrane solution be cast on a substrate material that can provide support for the fluid membrane solution during automated fabrication processes. However, it is important that the casting substrate utilized have minimum negative impacts upon the final process performance of the membrane. As such, it is preferred the substrate material be very thin, porous and allow the desired permeate materials to freely pass through the substrate. The substrate may be selective or non-selective of the desired components. Polymers, such as polytetrafluoroethylene (e.g., Teflon®), may be utilized as a substrate material.

However, for some applications, due to the low mechanical strength and high elasticity of many suitable polymer substrates, casting of the polymeric membrane solutions onto these unsupported substrates is not feasible utilizing typical commercial membrane casting equipment. In such cases, for the substrate to be compatible with the commercial casting equipment, an additional layer of a fibrous backing material (e.g. a fabric or felt-like backing material) such as poly metaphenylene isophthalamide (Nomex®) is used to provide better handling characteristics during the manufacturing of the membrane sheets.

However, in the prior art, when the final as-cast membrane material is put into a separations process application, the membrane assembly has been oriented with the backing material facing the permeate side of the process. FIG. 1 shows the process orientation of such a membrane assembly and process orientation of the prior art. In this orientation, the backing material imparts the greatest additional strength to the membrane assembly by being positioned on the low pressure (permeate) side of the membrane assembly which is subjected to the tensile bending stresses induced by the process application. In both the perstraction and pervaporation processes, the permeate side is the low pressure side of the process and thus the membrane is placed with the backing material facing the permeate side of the process.

Unfortunately, this fibrous layer can negatively impact the process performance of the membrane. This performance reduction can occur regardless of whether the final membrane assembly is installed into a plate and frame membrane configuration, a wafer membrane configuration, or a spiral wound membrane configuration.

Therefore, there exists in the industry a need for improvements in the separation performance of polymeric membranes that are cast utilizing fibrous backing materials.

### SUMMARY OF THE INVENTION

This invention includes an improved membrane assembly for polymeric membrane materials that utilize a fibrous backing material during fabrication in a commercial membrane casting process. This invention also includes an improved separations process for utilizing the improved membrane assembly.

A preferred embodiment of the present invention is a membrane assembly for separating a permeate stream rich in a desired component from a hydrocarbon feedstream, comprising:

a) a polymeric membrane with a top side and a bottom side;

b) a casting substrate with a top side and a bottom side, wherein the top side of the casting substrate is in contact with the bottom side of the polymeric membrane;

c) a fibrous backing with a top side and a bottom side, wherein the top side of the fibrous backing is in contact with the bottom side of the casting substrate; and

d) a polymer film with a top side and a bottom side, wherein the bottom side of the polymer film is in contact with the top side of the polymeric membrane.

Another preferred embodiment is a process for producing a rich permeate stream from a hydrocarbon feedstream, comprising:

a) contacting the hydrocarbon feedstream with a membrane assembly comprised of:

i) a polymeric membrane with a top side and a bottom side;

ii) a casting substrate with a top side and a bottom side, wherein the top side of the casting substrate is in contact with the bottom side of the polymeric membrane;

iii) a fibrous backing with a top side and a bottom side, wherein the top side of the fibrous backing is in contact with the bottom side of the casting substrate; and

iv) a polymer film with a top side and a bottom side, wherein the bottom side of the polymer film is in contact with the top side of the polymeric membrane;

wherein the hydrocarbon feedstream is in contact with the bottom side of the fibrous backing; and

b) retrieving a rich permeate stream from the top side of the polymer film;

wherein the concentration by wt % of a desired component in the rich permeate stream is higher than the concentration by wt % of the desired component in the hydrocarbon feedstream.

In a more preferred embodiment, the hydrocarbon feedstream is comprised of aromatics and non-aromatics, and the desired component is an aromatic.

### BRIEF DESCRIPTION OF THE DRAWINGS

FIG. 1 hereof shows a typical polymeric membrane assembly of the prior art wherein a polymeric membrane is incorporated onto a substrate and a fibrous backing material. Also shown is the orientation of this membrane assembly in a typical fluid separations process.

FIG. 2 hereof shows one embodiment of a membrane assembly wherein the polymeric membrane is incorporated onto a suitable substrate and fibrous backing material. Additionally, a polymer film material is installed on the opposite side of the polymeric membrane from the fibrous backing material. The entire membrane assembly is then inverted with respect to the prior art for use in the process of the present invention. The membrane assembly is shown in the figure in this inverted position for use in a fluid separations process in accordance with the present invention.

### DETAILED DESCRIPTION OF THE PREFERRED EMBODIMENTS

As used herein, the term “hydrocarbon” means an organic compound having a predominantly hydrocarbon character. Accordingly, organic compounds containing one or more non-hydrocarbon radicals (e.g., sulfur or oxygen) would be within the scope of this definition. As used herein, the terms “aromatic hydrocarbon” or “aromatic” means a hydrocarbon-based organic compound containing at least one aromatic ring. The rings may be fused, bridged, or a combination of fused and bridged. In a preferred embodiment, the aromatic species separated from the hydrocarbon feed contains one or two aromatic rings. The terms “non-aromatic hydrocarbon” or “non-aromatic” or “saturate” means a hydrocarbon-based organic compound having no aromatic cores. Also as used herein, the term “selectivity” means the ratio of the desired component(s) in the permeate to the non-desired component(s) in the permeate divided by the ratio of the desired component(s) in the feedstream to the non-desired component(s) in the feedstream. Also, the term “flux” or “normalized flux” is defined the mass rate of flow of the permeate across a membrane usually in dimensions of Kg/m²-day, Kg/m²-hr, Kg-μm/m²-day, or Kg-μm/m²-hr. Also used herein, the term “selective” means that the described part has a tendency to allow one or more specific components of the feedstream to preferentially pass through that part with respect to the other feedstream components. The term “non-selective” means that the described element has no tendency to allow one or more specific components of the feedstream to preferentially pass through that element with respect to the other feedstream components.

This invention is an improved membrane assembly and an improved separations process configuration for polymeric membranes commercially cast on fibrous backing materials. The fibrous backing materials provide a strong and stable membrane support platform fabrication of membrane assemblies utilizing commercial sheet membrane casting equipment.

The present invention adds a separate layer of a polymer film material to the face of a polymeric membrane opposite of the fibrous backing material. The membrane assembly is placed is an inverted orientation in a separations process, that is, that the membrane assembly of the present invention is oriented with the fibrous backing side of the membrane assembly facing the retentate (feedstream) side of the process. This reorientation of backing material with respect to the process flow unexpectedly results in an increase in the permeate flux rates. It is believed that by removing the fibrous material from the permeate side of the membrane process, the permeate material can more rapidly disengage from the permeate face of the membrane. In turn, the resultant decrease in permeate concentration at the membrane permeate face increases the diffusion equilibrium in the membrane, resulting in an overall improvement in the separations performance for the membranes and associated processes of the present invention.

A polymer film material is added to the face of the membrane opposite of the fibrous backing and supplies additional strength to the membrane assembly during operation in the reversed configuration of the present invention. In a preferred embodiment, this film layer is comprised of a low surface tension material which contributes to the improved membrane performance by improving the release efficiency of the permeate from the permeate face of the membrane. As a result, membrane fabrication processes can be easily modified to benefit from the improved process selectivity and flux performance of the present invention.

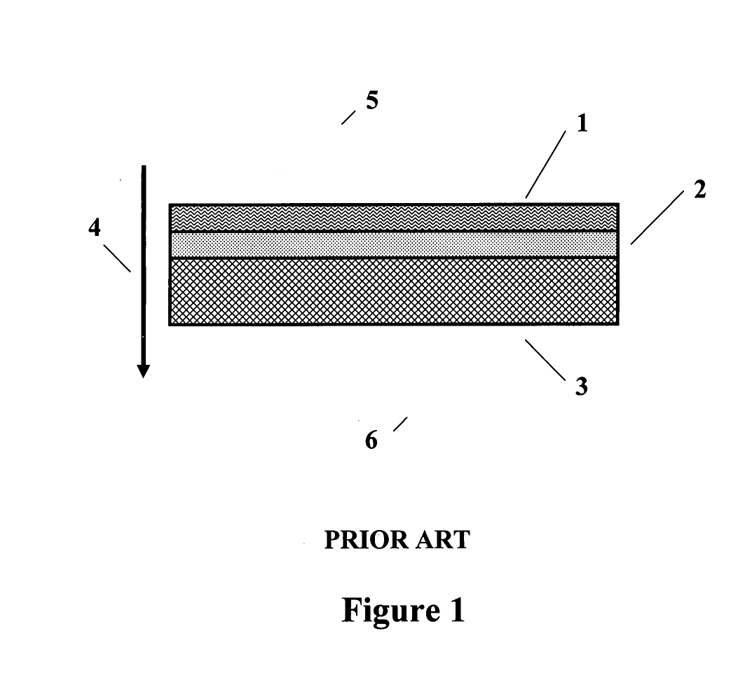

FIG. 1 depicts the membrane assembly and process configuration of the prior art. The membrane assembly of the prior art consists of a polymeric membrane (1) which is incorporated onto a suitable casting substrate material (2). This substrate layer can be either selective or non-selective with respect to the feedstream components. The casting substrate properties are selected such that it will support and contain the polymeric membrane material in solution during the casting and curing phases of the fabrication, but also has sufficient porosity to allow the desired components to pass through its layer. However, preferred materials for utilization as substrates often do not possess enough strength and geometric stability to allow the material to act as the sole membrane support for use in commercial membrane fabrication processes. Therefore, a fibrous backing material (3) is utilized to provide the strength and stability necessary to fabricate the membrane in the commercial casting equipment. This backing material is primarily utilized for its strength and handling capabilities and therefore is usually comprised of an inert, porous and non-selective material. FIG. 1 also shows the direction of flow of the selective stream components (4) across the membrane assembly configuration and associated process configuration of the prior art from the retentate side (5) of the process to the permeate side (6) of the membrane assembly. As can be seen, here the flow through the membrane contacts the layers of the membrane assembly in the order of the main polymeric membrane (1), followed by the casting substrate (2), and lastly, the fibrous backing material (3) where the permeate material is released into the permeate stream (6).

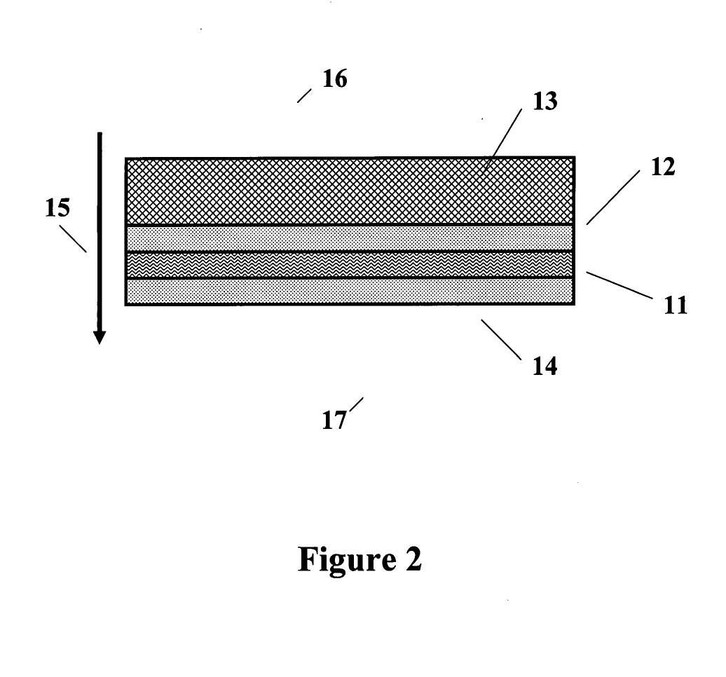

FIG. 2 depicts the membrane assembly and process configuration of a preferred embodiment of the present invention. The membrane assembly of the present invention consists of a polymeric membrane (11) which is incorporated upon a suitable substrate material (12). The substrate material can be either selective or non-selective with respect to the feedstream components. A fibrous material is utilized as a backing material (13) for the membrane substrate and provides the necessary strength and stability required to cast the membrane assembly in commercial casting equipment. This fibrous backing material is primarily utilized for its strength and handling capabilities and therefore is usually comprised of an inert, porous and non-selective material. A polymer film (14) is added to the exposed face of the polymeric membrane (i.e., the face of the membrane opposite of the backing material). This is done to provide strength to the membrane assembly for when the present invention is installed in an “inverted process configuration” with respect to the prior art. The apparatus and process of the present invention can also be improved by selecting a polymer film that has low surface tension characteristics which can improve the permeate release efficiency in the process, thereby improving the overall mass transport properties of the membrane assembly.

As can be seen in this FIG. 2, when installed in a separations process, the orientation of the membrane assembly of the present invention is inverted with respect to the assemblies of the prior art. FIG. 2 shows the direction of flow of the selective stream components (15) across the membrane in the present invention from the retentate side (16) of the process to the permeate side (17) of the membrane assembly. As can be seen, the flow through the membrane contacts the layers of the membrane assembly in the opposite direction from the assemblies and processes of the prior art in the order of first the fibrous backing material (13), followed by the substrate material (12), followed by the polymeric membrane (11), and lastly the polymer film material (14).

The membrane assemblies of the present invention may be installed into suitable membrane element housing configurations known in the art, including but not limited to, flat plate elements, wafer elements, and spiral-wound elements. The primary function required of the membrane element housing is to enclose the layers of the membrane assembly; provide a path for the feedstream to contact the membrane; provide connections for a retentate stream and a permeate stream to be removed as separate streams from the housing; and prevent significant bypassing of stream components from the feedstream/retentate side of the membrane assembly to the permeate side of the membrane assembly without the components of the permeate stream passing through all of the layers of the membrane assembly.

The polymer film material may be applied directly to the polymer membrane face or it may be added as a separate film sheet. In a preferred embodiment, the polymer film is comprised of a compound selected from polytetrafluoroethylene (e.g., Teflon®), polyvinylfluoride, polyvinylidenefluoride, polyurethane, polypropylene, polyethylene, polycarbonate, polysulfone, and silicone. Preferably, the polymer film is comprised of a compound selected from polytetrafluoroethylene, polyvinylfluoride, and polyvinylidenefluoride.

In a preferred embodiment, the present invention is comprised of a fibrous material backing selected from aromatic polyamide fibers (e.g., Nomex® and Kevlar®), polyester fibers, nylons fibers, activated carbon fibers, and combinations thereof.

In another preferred embodiment, the membrane assemblies and the associated process configurations of the present invention are particularly benefited when the polymeric membrane is comprised of a dianhydride, a diamine, a crosslinking agent and a difunctional dihydroxy polymer selected from:

a) dihydroxy end-functionalized ethylene propylene copolymers with an ethylene content from about 25 wt % to about 80 wt %;

b) dihydroxy end-functionalized ethylene propylene diene terpolymers with an ethylene content from about 25 wt % to about 80 wt %;

c) dihydroxy end-functionalized polyisoprenes; dihydroxy end-functionalized polybutadienes; dihydroxy end-functionalized polyisobutylenes;

d) dihydroxy end-functionalized acrylate homopolymers, copolymers and terpolymers; dihydroxy end-functionalized methacrylate homopolymers, copolymers and terpolymers; and mixtures thereof,
wherein the mixtures of acrylate and methacrylate monomers range from C₁ to C₁₈;

e) dihydroxy end-functionalized condensation homopolymers, copolymers, terpolymers and higher order compositions of structurally different monomers, including alcohol-terminated end-functionalized esters and dihydroxy end-functionalized multimonomer polyesters; and mixtures thereof;

wherein the polyalkyladipate structures range from C₁ to C₁₈;

f) dihydroxy end-functionalized perfluoroelastomers;

g) dihydroxy end-functionalized urethane homopolymers, copolymers, terpolymers, and higher order compositions of structurally different monomers;

h) dihydroxy end-functionalized carbonate homopolymers, copolymers, terpolymers, and higher order compositions of structurally different monomers;

i) dihydroxy end-functionalized ethylene alpha-olefin copolymers; dihydroxy end-functionalized propylene alpha-olefin copolymers; and dihydroxy end-functionalized ethylene propylene alpha-olefin terpolymers;

wherein the alpha-olefins are linear or branched and range from C₃ to C₁₈;

j) dihydroxy end-functionalized styrene homopolymers, copolymers, terpolymers, and higher order compositions of structurally different monomers;

k) dihydroxy end-functionalized silicone homopolymers, copolymers, terpolymers, and higher order compositions of structurally different monomers;

i) dihydroxy end-functionalized styrene butadiene copolymers; dihydroxy end-functionalized styrene isoprene copolymers; and

m) dihydroxy end-functionalized styrene butadiene block copolymers; and dihydroxy end-functionalized styrene isoprene block copolymers.

In a preferred embodiment, the cross-linking agent is selected from diepoxycyclooctane, diepoxyoctane, 1,3-butadiene diepoxide, glycerol diglycidyl ether, bisphenol A diglycidyl ether, 1,4-butanediol diglycidyl ether, 1,4-cyclohexanedimethanol diglycidyl ether, bisphenol F diglycidyl ether, neopentyl glycol diglycidyl ether, poly(propylene glycol) diglycidyl ether, or a mixture thereof.

The membrane assemblies described herein are useful for separating a selected component or species from a liquid feed, a vapor/liquid feed, or a condensing vapor feeds. The resultant membranes of this invention can be utilized in both perstractive and pervaporative separation processes.

In a preferred embodiment, the permeate is removed from the permeate zone by a liquid or vapor sweep stream. The permeate dissolves into the sweep stream and is conducted away by sweep stream flow in order to prevent the accumulation of permeate in the permeate zone.

Membrane separation will preferentially operate at a temperature less than the temperature at which the membrane performance would deteriorate or the membrane would be physically damaged or decomposed. For hydrocarbon separations, the membrane temperature would preferably range from about 32° F. to about 950° F. (0 to 510° C.), and more preferably from about 75° F. to about 500° F. (24 to 260° C.).

In a still another preferred embodiment, the operating pressure range in the retentate zone is from about atmospheric pressure to about 150 psig. The operating pressure ranges in the permeate zone is from about atmospheric pressure to about 1.0 mm Hg absolute.

The membranes of this invention are useful for separating a desired species or component from a feedstream, preferably a hydrocarbon feedstream.

In a preferred embodiment, the membrane compositions and configurations above are utilized for the selective separation of aromatics from a hydrocarbon feedstream containing aromatics and non-aromatics.

In another embodiment, the membrane compositions and configurations above are utilized to selectively separate sulfur and nitrogen heteroatoms from a hydrocarbon feedstream containing sulfur heteroatoms and nitrogen heteroatoms.

In still another embodiment, the hydrocarbon feedstream is a naphtha with a boiling range of about 80 to about 450° F. (27 to 232° C.), and contains aromatic and non-aromatic hydrocarbons. In a preferred embodiment, the aromatic hydrocarbons are separated from the naphtha feedstream. As used herein, the term naphtha includes thermally cracked naphtha, catalytically cracked naphtha, and straight-run naphtha. Naphtha obtained from fluid catalytic cracking processes (“FCC”) are particularly preferred due to their high aromatic content.

Although the present invention has been described in terms of specific embodiments, it is not so limited. Suitable alterations and modifications for operation under specific conditions will be apparent to those skilled in the art. It is therefore intended that the following claims be interpreted as covering all such alterations and modifications as fall within the true spirit and scope of the invention.

### EXAMPLE

In this example two test assemblies were constructed to simulate the prior art membrane assembly configuration (herein designated as “Configuration 1”) and the present invention membrane assembly configuration (herein designated as “Configuration 2”). It should be clarified that the only the assembly configuration of Configuration 1 used in this example is considered prior art and that the membrane composition itself utilized in Configuration 1 is not considered prior art.

In order to simulate both assembly configurations, a membrane sheet of a PEA-DECO material was fabricated as follows. In the synthesis, 5 g (0.025 moles) of polyethylene adipate (PEA) diol (2000 g/mole) was reacted with 1.09 g (0.005 moles) of pyromellitic dianhydride (PMDA) to make a prepolymer in the end-capping step (165° C. for 6.5 hours). To this solution was added 25 g of dimethylformamide (DMF). The temperature was allowed to decrease to 70° C. A separately prepared solution of 0.67 g (0.0025 moles) of 4,4-methylene bis(2-chloroaniline) (MOCA) dissolved in 5 g DMF was subsequently added. In the DMF solution, one mole of the prepolymer reacts with one mole of MOCA to make a copolymer containing polyamic acid hard segment and PEA soft segment in the chain-extension step. An additional 59.5 g of DMF was then added. Subsequently, 89.5 g of acetone was added to prevent gelling. The resulting solution was then stirred for 1.5 hours at 70° C. The solution was then cooled to room temperature under continual stirring conditions. Diepoxycyclooctane (0.70 g, 0.005 moles) was added to the copolymer-DMF solution at a diepoxide/PEA molar ratio of 2. The result is a 4 wt % polymer solution in 50/50 DMF/acetone.

The final solution was cast onto a porous support of 0.2 micron porous Gore-Tex® Teflon® and the thickness was adjusted by controlling the grams of polymer deposited on the porous Teflon® material to a uniform loading of 0.002172 g/cm². The membrane casting was first dried for 30 minutes at 93° C. (200° F.) to remove most of the solvent (i.e., solvent evaporation), and subsequently low-temperature cured to promote chemical cross-linking at 174° C. (345° F.) for 2 hours. Test discs were cut from the final PEA-DECO membrane sheet for use in each of the two configuration test assemblies.

The Configuration 1 assembly consisted of placing the following items in order into a 5.0 cm (1.97″) diameter membrane holder: 1) the PEA-DECO membrane sheet as synthesized above with the casting substrate oriented on the permeate side of the PEA-DECO membrane, and 2) a layer of Nomex® fiber sheet made by Dupont®. The Configuration 2 assembly consisted of placing the following items in order into a 5.0 cm (1.97″) diameter membrane holder: 1) a layer of Nomex® fiber sheet made by Dupont®, 2) the PEA-DECO membrane sheet as synthesized above with the casting substrate oriented on the feed/retentate side of the PEA-DECO membrane, and 3) a 0.1 micron porous Gore-Tex® Teflon® polymer film. The membrane holders were sealed with a teflon o-ring to prevent bypassing of the selective permeated components between the assembly layers.

The membrane coupons were evaluated using a heavy cat naptha feed. The orientation of the Configuration 1 membrane assembly was such that layer 1) was in contact with the feedstream/retentate side of the test assembly and layer 2) was in contact the permeate side of the test assembly. Similarly, orientation of the Configuration 2 membrane assembly was such that layer 1) was in contact with the feedstream/retentate side of the test assembly and layer 3) was in contact the permeate side of the test assembly.

It should be noted that Configuration 1 simulated the membrane assembly & orientation of the prior art with the fibrous backing material facing the permeate side of the process (similar to as shown in FIG. 1). The membrane assembly simulating the present invention (Configuration 2) was oriented in the testing process in an “inverted” position with the side of the assembly with the backing material facing the feedstream or retentate side of the process (similar to as shown in FIG. 2).

The selectivity and flux performances of the two membrane assembly configurations and their associated process configurations is shown in Table 1.

TABLE 1

| | CONFIG- | CONFIGURATION | |
|---|---|---|---|
| | URATION | #2 | |
| | #1 | (Embodiment of | |
| | (Prior Art | Present Invention | Improvement |
| | Membrane | Membrane | in |
| | Configuration) | Configuration) | Performance |
| Temperature (° C.) | 145.3 | 145.3 | |
| Feed Pressure (psig) | 22 | 22 | |
| Permeate Pressure | 4.2 | 3.0 | |
| (mm of Hg) | | | |
| Permeate Selectivity | 2.79 | 3.06 | 9.7% |
| Permeate Flux | 50.1 | 71.4 | 42.5% |
| (Kg/m²/D) | | | |

As can be seen, the membrane assembly and configuration of the present invention (Configuration 2) results in almost a 10% improvement in selectivity and over a 40% improvement in flux over the membrane assemblies and configurations of the prior art.

What is claimed is:

1. A membrane assembly for separating a permeate stream rich in a desired component from a hydrocarbon feedstream, comprising:
a) a polymeric membrane with a top side and a bottom side;
b) a casting substrate with a top side and a bottom side, wherein the top side of the casting substrate is in contact with the bottom side of the polymeric membrane;
c) a fibrous backing with a top side and a bottom side, wherein the top side of the fibrous backing is in contact with the bottom side of the casting substrate; and
d) a polymer film with a top side and a bottom side, wherein the bottom side of the polymer film is in contact with the top side of the polymeric membrane.

2. The membrane assembly of claim 1, wherein the polymeric membrane is comprised of a dianhydride, a diamine, a crosslinking agent and a difunctional dihydroxy polymer selected from:
a) dihydroxy end-functionalized ethylene propylene copolymers with an ethylene content from about 25 wt % to about 80 wt %;
b) dihydroxy end-functionalized ethylene propylene diene terpolymers with an ethylene content from about 25 wt % to about 80 wt %;
c) dihydroxy end-functionalized polyisoprenes; dihydroxy end-functionalized polybutadienes; dihydroxy end-functionalized polyisobutylenes;
d) dihydroxy end-functionalized acrylate homopolymers, copolymers and terpolymers; dihydroxy end-functionalized methacrylate homopolymers, copolymers and terpolymers; and mixtures thereof,
wherein the mixtures of acrylate and methacrylate monomers range from C₁ to C₁₈;
e) dihydroxy end-functionalized condensation homopolymers, copolymers, terpolymers and higher order compositions of structurally different monomers, including alcohol-terminated end-functionalized esters and dihydroxy end-functionalized multimonomer polyesters; and mixtures thereof;
wherein the polyalkyladipate structures range from C₁ to C₁₈;
f) dihydroxy end-functionalized perfluoroelastomers;
g) dihydroxy end-functionalized urethane homopolymers, copolymers, terpolymers, and higher order compositions of structurally different monomers;
h) dihydroxy end-functionalized carbonate homopolymers, copolymers, terpolymers, and higher order compositions of structurally different monomers;
i) dihydroxy end-functionalized ethylene alpha-olefin copolymers; dihydroxy end-functionalized propylene alpha-olefin copolymers; and dihydroxy end-functionalized ethylene propylene alpha-olefin terpolymers;
wherein the alpha-olefins are linear or branched and range from C₃ to C₁₈;
j) dihydroxy end-functionalized styrene homopolymers, copolymers, terpolymers, and higher order compositions of structurally different monomers;
k) dihydroxy end-functionalized silicone homopolymers, copolymers, terpolymers, and higher order compositions of structurally different monomers;
i) dihydroxy end-functionalized styrene butadiene copolymers; dihydroxy end-functionalized styrene isoprene copolymers; and
m) dihydroxy end-functionalized styrene butadiene block copolymers; and dihydroxy end-functionalized styrene isoprene block copolymers.

3. The membrane assembly of claim 2, wherein the fibrous backing is comprised of a material selected from aromatic polyamide fibers, polyester fibers, nylon fibers, activated carbon fibers, and combinations thereof.

4. The membrane assembly of claim 3, wherein the polymer film is comprised of a compound selected from polytetrafluoroethylene, polyvinylfluoride, polyvinylidenefluoride, polyurethane, polypropylene, polyethylene, polycarbonate, polysulfone, and silicone.

5. The membrane assembly of claim 1, wherein the desired component is an aromatic.

6. The membrane assembly of claim 4, wherein the desired component is an aromatic.

7. The membrane assembly of claim 4, wherein the desired component is a sulfur heteroatom.

8. The membrane assembly of claim 4, wherein the desired component is a nitrogen heteroatom.

9. The membrane assembly of claim 6, wherein the crosslinking agent is selected from diepoxycyclooctane, diepoxyoctane, 1,3-butadiene diepoxide, glycerol diglycidyl ether, bisphenol A diglycidyl ether, 1,4-butanediol diglycidyl ether, 1,4-cyclohexanedimethanol diglycidyl ether, bisphenol F diglycidyl ether, neopentyl glycol diglycidyl ether, poly(propylene glycol) diglycidyl ether, or a mixture thereof.

10. A process for producing a rich permeate stream from a hydrocarbon feedstream, comprising:
a) contacting the hydrocarbon feedstream with a membrane assembly comprised of:
i) a polymeric membrane with a top side and a bottom side;
ii) a casting substrate with a top side and a bottom side, wherein the top side of the casting substrate is in contact with the bottom side of the polymeric membrane;
iii) a fibrous backing with a top side and a bottom side, wherein the top side of the fibrous backing is in contact with the bottom side of the casting substrate; and
iv) a polymer film with a top side and a bottom side, wherein the bottom side of the polymer film is in contact with the top side of the polymeric membrane;
wherein the hydrocarbon feedstream is in contact with the bottom side of the fibrous backing; and
b) retrieving a rich permeate stream from the top side of the polymer film;
wherein the concentration by wt % of a desired component in the rich permeate stream is higher than the concentration by wt % of the desired component in the hydrocarbon feedstream.

11. The process of claim 10, wherein the hydrocarbon feedstream is comprised of aromatics and non-aromatics, and the desired component is an aromatic.

12. The process of claim 11, wherein the hydrocarbon feedstream is comprised of a naphtha with a boiling range of about 80 to about 450° F. (27 to 232° C.).

13. The process of claim 10, wherein the desired component is a sulfur heteroatom.

14. The process of claim 10, wherein the desired component is a nitrogen heteroatom.

15. The process of claim 11, wherein the polymeric membrane is comprised of a dianhydride, a diamine, a crosslinking agent and a difunctional dihydroxy polymer selected from:
a) dihydroxy end-functionalized ethylene propylene copolymers with an ethylene content from about 25 wt % to about 80 wt %;
b) dihydroxy end-functionalized ethylene propylene diene terpolymers with an ethylene content from about 25 wt % to about 80 wt %;
c) dihydroxy end-functionalized polyisoprenes; dihydroxy end-functionalized polybutadienes; dihydroxy end-functionalized polyisobutylenes;
d) dihydroxy end-functionalized acrylate homopolymers, copolymers and terpolymers; dihydroxy end-functionalized methacrylate homopolymers, copolymers and terpolymers; and mixtures thereof,
wherein the mixtures of acrylate and methacrylate monomers range from C₁ to C₁₈;
e) dihydroxy end-functionalized condensation homopolymers, copolymers, terpolymers and higher order compositions of structurally different monomers, including alcohol-terminated end-functionalized esters and dihydroxy end-functionalized multimonomer polyesters; and mixtures thereof;
wherein the polyalkyladipate structures range from C₁ to C₁₈;
f) dihydroxy end-functionalized perfluoroelastomers;
g) dihydroxy end-functionalized urethane homopolymers, copolymers, terpolymers, and higher order compositions of structurally different monomers;
h) dihydroxy end-functionalized carbonate homopolymers, copolymers, terpolymers, and higher order compositions of structurally different monomers;
i) dihydroxy end-functionalized ethylene alpha-olefin copolymers; dihydroxy end-functionalized propylene alpha-olefin copolymers; and dihydroxy end-functionalized ethylene propylene alpha-olefin terpolymers;
wherein the alpha-olefins are linear or branched and range from C₃ to C₁₈;
j) dihydroxy end-functionalized styrene homopolymers, copolymers, terpolymers, and higher order compositions of structurally different monomers;
k) dihydroxy end-functionalized silicone homopolymers, copolymers, terpolymers, and higher order compositions of structurally different monomers;
i) dihydroxy end-functionalized styrene butadiene copolymers;
dihydroxy end-functionalized styrene isoprene copolymers; and
m) dihydroxy end-functionalized styrene butadiene block copolymers; and dihydroxy end-functionalized styrene isoprene block copolymers.

16. The process of claim 15, wherein the fibrous backing is comprised of a material selected from aromatic polyamide fibers, polyester fibers, nylon fibers, activated carbon fibers, and combinations thereof.

17. The process of claim 16, wherein the polymer film is comprised of a compound selected from polytetrafluoroethylene, polyvinylfluoride, polyvinylidenefluoride, polyurethane, polypropylene, polyethylene, polycarbonate, polysulfone, and silicone.

18. The process of claim 17, wherein the hydrocarbon feedstream is comprised of a naphtha with a boiling range of about 80 to about 450° F. (27 to 232° C.).

19. The process of claim 18, wherein the process is performed under pervaporative conditions.
